(19) United States
(12) Patent Application Publication
(10) Pub. No.: US 2006/0232962 A1
(43) Pub. Date: Oct. 19, 2006

(54) Hazard marker kit

(75) Inventor: Bradford Altman, King George, VA (US)

Correspondence Address: MCHALE & SLAVIN, P.A., 2855 PGA BLVD, PALM BEACH GARDENS, FL, 33410, US

(73) Assignee: Safe and Sound Safety Corporation

(21) Appl. No.: 11/107,389

(22) Filed: Apr. 14, 2005

(51) Int. Cl. B60Q 1/26

(52) U.S. Cl. 362/227

(57) ABSTRACT

A hazard marker kit has several components including a hazard light, a base for supporting the light in different angular orientations on different surfaces, a translucent cone, and a staff with attached pennant. The hazard light is housed within a disc shaped high impact plastic housing, an upper portion of which is transparent. A plurality of LEDs are circularly disposed proximal to the side of the upper portion. A ring counter provides signals to transistors that sequentially drive the LEDs. Excitation provided to the ring counter is controlled to cause a desired current through the LEDs to simulate a rotating beacon, a flashing beacon or a continuous light.

### BACKGROUND OF THE INVENTION

1. Field of Invention

This invention is in the general field of warning devices and, more particularly, is a hazard marker kit that provides an aimed illumination device and accessories.

2. Description of the Prior Art

A hazard marker is typically placed near a problem area created by a mishap or breakdown. Reasons for placing the marker include protection of people against injury, discouraging people from either walking or driving in the problem area, discouraging intrusion into emergency medical treatment of injuries resulting from the mishap and discouraging intrusion into clean up activity. The hazard marker may, for example, be a flare, a sequentially illuminated arrow, a message sign, a wooden barricade that carries a blinking warning light or an orange cone.

The flare has an advantage of being easily visible at night. However, a motorist who drives past one or more flares may be temporarily blinded by their brightness, thereby endangering the motorist and people in the vicinity of the motorist. The flare is particularly dangerous to use where an automobile collision causes a spillage of gasoline on a roadway. Among other undesirable aspects of the flare is that a person charged with igniting the flare risks being burned and having their clothing burned. The flare additionally releases noxious fumes when it burns.

The orange cone is one of the most commonly used hazard markers. The cone frequently has a light and a battery mounted near its apex. The light cannot readily be seen outside of an immediate area where the cone is placed, particularly in poor weather conditions. The light and the battery make the cone top heavy, thereby destabilizing the cone. Even in the absence of the destabilizing, the cone is frequently destroyed or badly damaged when inadvertently struck by a motor vehicle.

In the boating industry, flares are typically used to indicate a vessel in peril. The use of a flare on a gasoline powered boat is very dangerous since a boat in peril is not moving, thus the opportunity for gasoline vapor accumulation is high. Once a flare is lit, the flare must be held over the side of the boat to prevent the hot molten materials from entering the vessel. Further, unlike a road side situation, a flare cannot be set down safely within a boat.

### SUMMARY OF THE INVENTION

Accordingly an objective of the present invention is to provide a hazard marker kit with components which are not necessarily usable simultaneously but would be available depending on the situation. The components include a hazard light and a base connected by a link which allows the light to be oriented in different planes of illumination. The kit also includes a translucent cone and a pennant with staff.

Another objective of the invention is to provide a hazard light in the general shape of a disc which includes a transparent upper housing and a lower housing that are made from a high impact plastic. The upper and lower housings form a waterproof seal when joined together.

Another objective of the present invention is to provide the hazard marker light including a plurality of light emitting diodes (LEDs) that have a circular disposition within the housing. The LEDs are oriented either to provide light that can be seen by a motorist at a substantial distance from the hazard marker or provide light that can be seen by an aircraft flying above the hazard marker.

A further objective of the invention is to provide an simulated rotating or flashing beacon using an oscillator driving an input of a ring counter. Outputs of the ring counter sequentially or simultaneously drive the LEDS. Current through the LEDS passes through a sampling resistor, thereby providing a sampling voltage. A reference voltage is compared to the sampling voltage. An excitation voltage applied to the ring counter is changed in response to a difference between the reference voltage and the sampling voltage. The change in the excitation causes a corresponding change in the drive at the output of the ring counter that results in the reference and sampling voltages being substantially equal.

Yet another objective of the invention is to provide a waterproof battery compartment in the lower housing for securing the batteries in operative connection regardless of the orientation of the hazard marker.

A further objective of the invention is to provide a double walled housing to reinforce the hazard marker against crushing.

Another objective of the invention is to provide a hazard marker that can be secured to slippery housings, such as boat surfaces.

Another objective of the invention is to provide an attachment on the housing for mounting the hazard marker on different angled surfaces.

A further objective of the invention is to provide a internal jumper switch to permit the LEDs of the hazard marker to fire simultaneously, as a flash, or sequentially, as a rotating beacon, or continuously for providing steady light.

Other objectives, features, and advantages of the invention should be apparent from the following description of the preferred embodiment thereof as illustrated in the accompanying drawing.

### BRIEF DESCRIPTION OF THE DRAWING

FIG. 1 is an exploded side view of the preferred embodiment of the hazard light of the present invention;

FIG. 2 is a top plan view of the embodiment of FIG. 1;

FIG. 3 is a side view of the base of the hazard light of the present invention;

FIG. 4 is a top plan view of the base of FIG. 3;

FIG. 5 is a side view of the belt clip of the present invention;

FIG. 6 is a top plan view of the link of this invention;

FIG. 7 is a perspective of the cone of this invention;

FIG. 8 is a perspective of the pennant and staff of this invention; and

FIG. 9 is a schematic showing of elements that cause illumination of the LEDS of this invention.

### DESCRIPTION OF THE PREFERRED EMBODIMENT

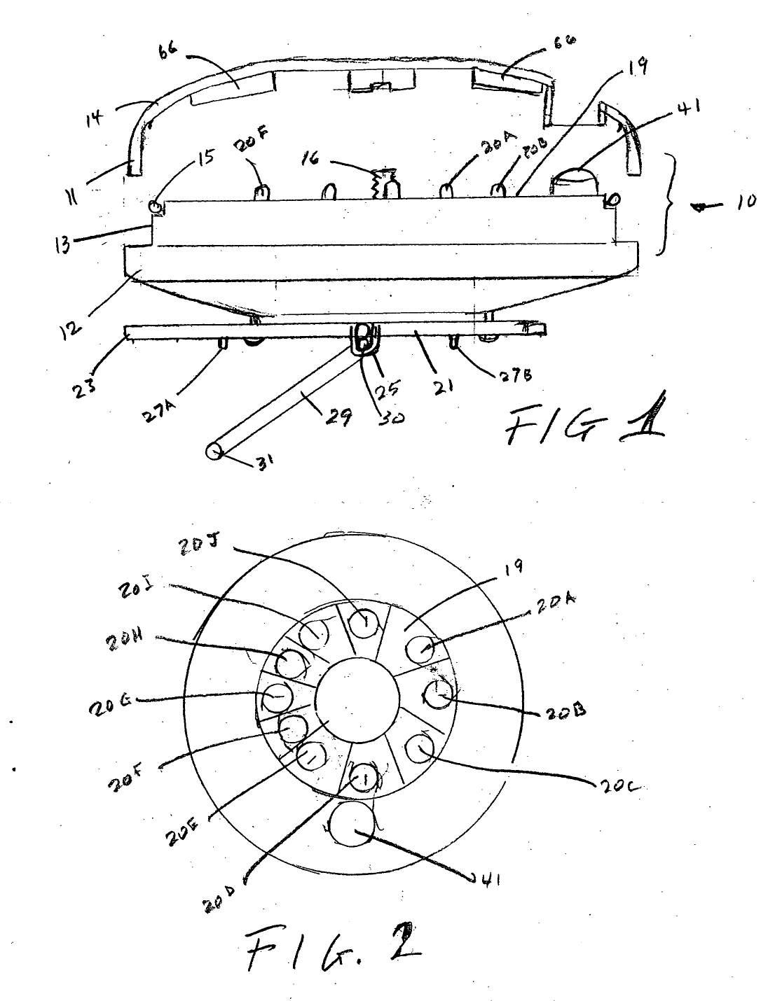

As shown in FIGS. 1 and 2, a hazard marker 10 has a general shape of a disc. The marker 10 includes a lower housing 12 and an upper housing 14 that are made from a high impact plastic. The upper housing 14 is transparent. A bolt 16 passes through the lower housing 12 and screws into the upper housing, whereby the lower housing 12 and the upper housing 14 are held together. The transparent upper housing 14 has a depending circular wall 11, shown in FIG. 1, with a diameter slightly smaller than the upstanding wall 13 of the lower housing 12. This double walled construction allows the hazard marker to be sealed against leakage. Also, a circumferential ring seal 15 supported by the upstanding wall 13 contacts upper housing 14 so that when the upper housing and the lower housing are bolted together they form a watertight joint.

Visible through the upper housing 14 is circular board 19, shown in FIG. 2, whereon LEDS 20-A through 20-J are circularly disposed. As explained hereinafter, the LEDs 20-A through 20-J transmit light through the wall 14. The LEDs 20A-20-J are oriented on the upper housing such that the emitted light may be seen for a considerable distance. The LEDs may have different emitted colors, such as white, red or blue, with other colors being possible. Red providing the traditional emergency color. However, white lighting may be used in direct sunlight providing a brilliant visual light.

The hazard marker 10 includes a latch 21 attached to the lower housing 12 by screws 22A and 22B. The latch is formed in a narrow elongated planar shape ending in a tongue 23. Also mounted on both sides of the latch 21 near the center on the lower surface are hoops 25. On either side of the hoops 25 are blades 27A and 27B sized and shaped to securely fit in catches 28A and 28B on base 26 when the hazard light 10 is parallel to the base 26. The tongue 23 is sized and shaped to securely fit between the upstanding walls 24A and 24B of the catch 28A when the hazard light is at a 45 degree angle to the base 26. The tongue 23 is secured in the catch 28B when the hazard light is normal to the base 26.

A link 29, as shown in FIG. 6, is rotatably coupled to the hoops 25 by upper pintles 30. Pintles 31 are rotatably secured in the loops 32 in the base 26. The hazard light 10 can be pivoted through an arc of 90 degrees relative to the base 26 by pivoting the link 29 and rotating the pintles 30 and 31 in the hoops 25 and loops 32.

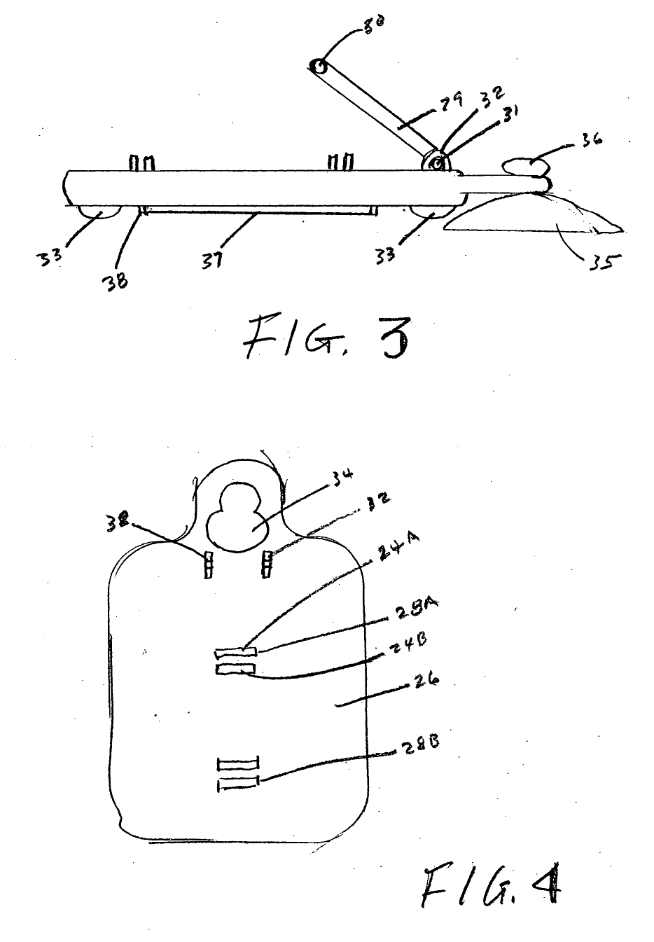

The base 26, illustrated in FIGS. 3 and 4, is preferably a planar rectilinear shape with feet 33 at the corners. However, the outline of the base is a matter of choice.

The base 26 has a key hole opening 34 in one end. Removably inserted into the key hole opening is a suction cup 35 which is slidably secured by a button 36 frictionally held in the small end of the key hole opening. The suction cup 35 will secure the hazard light 10 to all smooth surfaces, such as glass, plexiglass, and finished painted or unpainted surfaces in either the vertical or horizontal plane.

A magnet 37, shown in FIG. 3, is mounted on the bottom surface of the base 26. The magnet 37 may be snap-fit into a retainer 38 or permanently affixed to the base. The magnet 37 permits the hazard light to be attached to,magnetizable metal surfaces, such as steel, at any orientation.

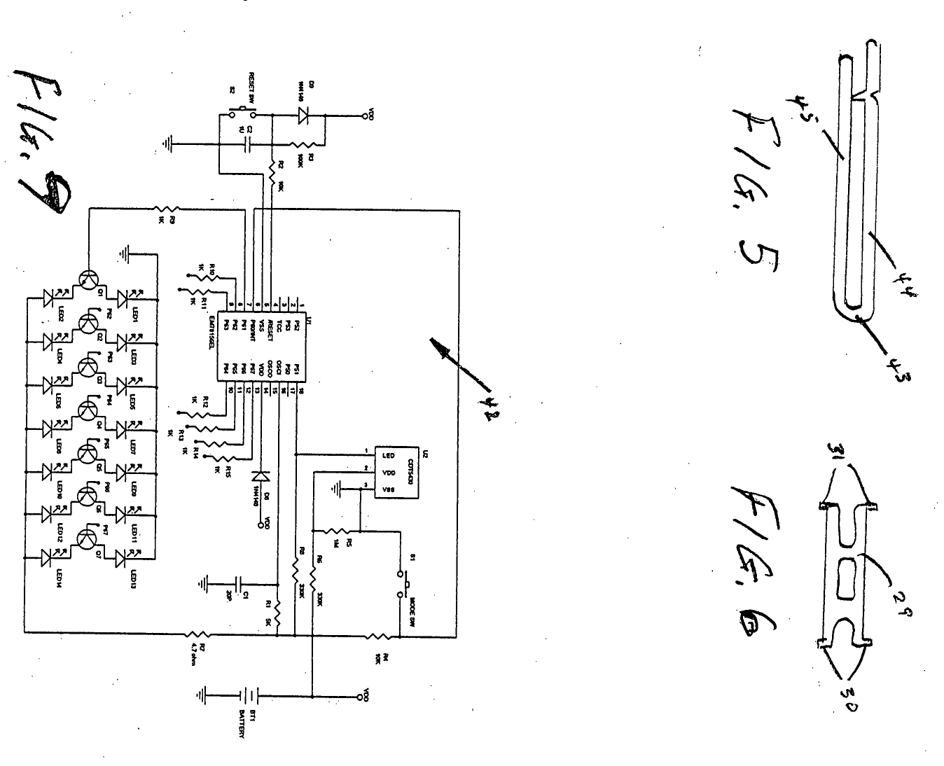

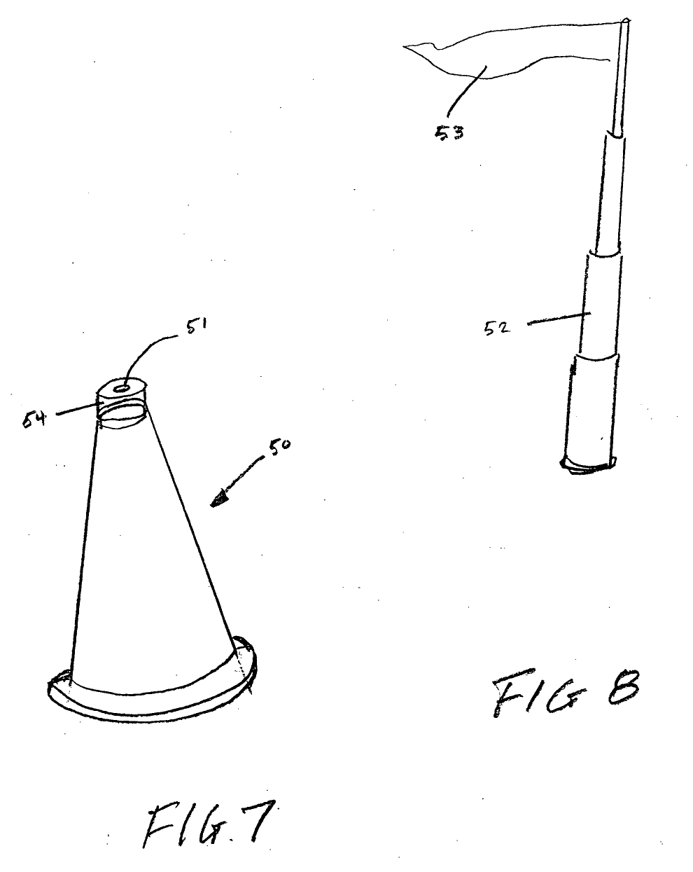

A spring steel clip 43, shown in FIG. 5, is magnetically attached to the magnet 37 which allows the hazard light 10 to be attached to clothing, such as a collar, waistband or a belt or a line by compression between the opposing arms 44 and 45.

Batteries (not shown) are connected in series. More particularly, the batteries are placed in the battery compartment to form an electrical connection from the battery compartment to the terminals connected to the circuit board 19.

To replace or recharge the batteries, the upper and lower housings must be disassembled and reattached using bolt 16. Of course, there could be a sealed door in the lower housing 12 connecting to the battery compartment for ease of battery replacement.

A sealed switch 41 is mounted on the lower housing 12 and projects through the upper housing 14 for manual activation of the hazard light. The switch 41 is connected to the electrical battery circuit in the compartment. By manipulating the switch power is interrupted or connected between the batteries and the circuit board 42, shown schematically in FIG. 9. The hazard marker may operate in a rotating mode with the LEDs firing sequentially or in the flash mode with the LEDs firing simultaneously or in the continuous mode. The circuit board has a microprocessor controlling the different modes. The mode is selected by manipulation of the switch 41.

The upper housing 14 has radial depressions 66 therein that diffuses light from the LEDs 20-A through 20-J that passes therethrough. The diffused light does not cause a glare that temporarily blinds a passing motorist. The LEDs 20-A through 20-J are positioned to transmit light vertically through a horizontal wall portion of the upper housing 14. The vertically transmitted light is used to indicate a scene of a mishap to an aircraft.

As shown in FIG. 9, there is a connection between the batteries and switch 41. When the switch 41 closes, thereby providing a voltage to a contact which is connected to an operational amplifier and an oscillator, whereby the voltage is provided to the operational amplifier and the oscillator.

The oscillator provides a train of pulses with an 18 millisecond period. The oscillator is connected to a ring counter at a clock input. A first pulse and a second pulse of the train of pulses cause an output of the ring counter to provide an 18 millisecond pulse. The second pulse and a third pulse cause an output of the ring counter to provide an 18 millisecond pulse. It should be understood that the pulse ends simultaneously with a beginning of the pulse. In a similar manner, 18 millisecond pulses are provided at other outputs, respectively, of the ring counter. From the explanation given hereinbefore the pulses are provided in a serial manner, one at a time. It should be understood that the amplitude of the pulses is directly related to a voltage applied to an excitation input of the ring counter. The application of the voltage to the excitation input is described hereinafter.

The outputs are connected to bases of NPN transistors respectively. The transistors have their collectors respectively connected to LEDs 20-A, 20-C, 20-E, 20-G, 20-I, at their cathodes, anodes thereof being all connected to the contact. The transistors have their emitters respectively connected to the LEDs 20-B, 20-D, 20-F, 20-H, 20-J, at their anodes, cathodes thereof being all connected through a sampling resistor to ground and to the operational amplifier at an inverting input thereof, whereby a sampled voltage is provided to the amplifier.

When the switch 41 is closed, substantially equal currents flow through the LEDs 20-A in response to the pulse being provided to the transistor, thereby causing an emission of light from the LED 20A. In a similar manner, current flows through the LEDs 20-C, 20-D, the LEDs 20-E, 20-F, the LEDs 20-G, 20-H, the LEDs 20-I, 20-J, in response to the pulses respectively, to cause emissions of light therefrom.

The contact is connected through a resistor to a non-inverting input of the amplifier. A resistor is connected from the non-inverting input to ground. In other words, the resistors are a voltage divider that provides a reference voltage to the non-inverting input. An output of the amplifier is connected to an excitation input of the ring counter whereby an excitation input voltage is provided to the ring counter.

When, for example, the pulse is provided, an emitter current of the transistor passes through the resistor, thereby providing the sampled voltage. In response to the sampled voltage being greater than the reference voltage, the excitation input voltage is reduced, thereby reducing the amplitude of the pulse to cause a reduction of the emitter current of the transistor. Correspondingly, in response to the sampled voltage being less than the reference voltage, the excitation input voltage is increased, thereby increasing the amplitude of the pulse, to cause an increase of the transistor emitter current, whereby the amplitude of the pulse is regulated. In a similar manner, the amplitudes of the pulses are regulated.

In an alternative embodiment, the diodes 20-A, 20-C, 20-E, 20-G, 20-I, and 20-K, are omitted and the collectors of transistors are connected to the contact. Thus there is described herein a hazard marker and distress signal that is especially suited for marking a problem area created by a mishap or mechanical failure.

In addition the hazard light 10, and the attached accessories, the hazard marker kit also includes a transparent or translucent cone 50. The cone 50 is similar to a conventional traffic cone except that it is lighted from within when it is placed over a hazard light. The illuminated cone 50 may be used with the hazard light in any mode particularly in roadside situations. The cone 50 may be fabricated from films with other colors, such as blue, red, yellow or orange, to attract attention or distinguish the hazard from other lights nearby. The cone has an aperture 51 in the apex.

The cone 50 may be combined with the telescoping staff 52 extending through the aperture 51. This is particularly useful in marine and helicopter operations where knowledge of the wind direction is necessary for proper approach to the scene. A pennant 53 is attached to one end of the staff to indicate wind direction. The hazard light projecting up through the cone will illuminate the pennant 52.

The cone 50 and staff 52 may be used with or without the lens 54 which is sized and shaped to fit within aperture 51. The lens 54 will focus the light from the hazard light to provide a vertical beam useful in aerial location of a site.

A number of embodiments of the present invention have been described. Nevertheless, it will be understood that various modifications may be made without departing from the spirit and scope of the invention. Accordingly, it is to be understood that the invention is not to be limited by the specific illustrated embodiment but only by the scope of the appended claims.

What is claimed is:

1. A hazard marker comprising a waterproof disc shaped hazard light with a lower housing and a transparent upper housing, a waterproof seal between said upper housing and said lower housing, a circuit board mounted in said lower housing, a waterproof battery compartment and a plurality of light sources circularly disposed within said upper housing proximal to a wall thereof operatively connected with said circuit board, and means for causing emission of light from said light sources.

2. The hazard marker of claim 1 wherein each of said plurality of light sources is an LED.

3. The hazard marker of claim 1 wherein said plurality of light sources are activated in sequence.

4. The hazard marker of claim 3 wherein said sequence simulates a rotating beacon.

5. The hazard marker of claim 1 wherein said plurality of light sources are activated simultaneously.

6. The hazard marker of claim 5 wherein said plurality of light sources are activated intermittently.

7. The hazard marker of claim 1 wherein a said circuit board includes:
an oscillator;
a ring counter having a clock input connected to said oscillator at an output thereof, a plurality of outputs of said ring counter each providing a voltage having an amplitude directly related to a voltage applied to an excitation input of said ring counter;
means for generating currents directly related to voltages provided at said ring counter outputs, said generated currents being respectively provided through a plurality of LEDs;
a sampling resistor that provides a return path for current that passes through said LEDs;
a reference voltage source; and
an operational amplifier that has inverting and non inverting inputs connected to said sampling resistor and said reference voltage source, respectively, and an output connected to said excitation input of said ring counter.

8. The hazard marker of claim 7 wherein each of said circuit board comprises an NPN transistor with its base connected to an output of said ring counter, its emitter connected to an anode of one of said LEDs and its collector connected to a source of excitation.

9. The hazard marker of claim 8 wherein said collector is connected to said source of excitation through one of said LEDs having its cathode connected to said collector.

10. A hazard marker for providing a warning light comprising a disc shaped marker having a translucent upper housing and a bottom housing, said upper housing having a depending wall, said bottom housing having an upstanding wall, said depending wall and said upstanding wall forming concentric circles in contact with each other, said concentric circles reinforcing said disc shaped housing and increasing crush resistence, a circuit board in said marker, a circular array of LEDs in said upper housing electrically connected to said circuit board, said circuit board having means for energizing each LED of said array, a latch attached to said lower housing, said latch rotatably connected to a link, and a base for supporting said disc shaped marker rotatably connected to said link.

11. A hazard marker of claim 10 wherein said circuit board has means for energizing each LED in said array simultaneously and intermittently for producing a visible light that appears to flash.

12. A hazard marker of claim 10 wherein said circuit board has means for energizing each LED in said array sequentially and intermittently for producing a visible light that appears to rotate.

13. A hazard marker of claim 10 wherein said housing is made of high impact plastic.

14. A hazard marker of claim 10 wherein said upper housing has a depending wall, said bottom housing having an upstanding wall, a circular waterproof seal between said upstanding wall and said depending wall.

15. A hazard marker of claim 10 wherein said base includes a magnet for holding said marker on magnetizable surfaces.

16. A hazard marker of claim 15 wherein said base includes a suction cup for holding said marker on smooth finished surfaces.

17. A hazard marker of claim 10 wherein said base includes a suction cup for holding said marker on smooth finished surfaces.

18. A hazard marker kit for providing a warning light comprising a disc shaped marker having a translucent upper housing and a bottom housing, said upper housing having a depending wall, said bottom housing having an upstanding wall, said depending wall and said upstanding wall forming concentric circles in contact with each other, said concentric circles reinforcing said disc shaped housing and increasing crush resistence, a circuit board in said marker, a circular array of LEDs in said upper housing electrically connected to said circuit board, said circuit board having means for energizing each LED of said array, a latch attached to said lower housing, said latch rotatably connected to a link, and a base for supporting said disc shaped marker rotatably connected to said link, a magnet in said base for holding said marker on magnetizable surfaces, a suction cup for holding said marker on smooth finished surfaces, said base including a plurality of catches whereby said latch and said link support said marker at an angle from said base when said latch is engaged in said plurality of catches.

19. A hazard marker kit of claim 18 wherein said kit includes a hollow cone of a size and shape to surround said marker, said cone being translucent whereby said cone is illuminated when said LEDs are energized.

20. A hazard marker kit of claim 19 wherein said kit includes a telescoping staff, said cone having an aperture at inserted in said aperture, a pennant attached to one the other end of said staff for indicating wind direction.

21. A hazard marker kit of claim 19 wherein said kit includes a lens, said lens of a size and shape to fit within said cone, said lens adapted to project light vertically from said cone.
